(19) United States
(12) Patent Application Publication
(10) Pub. No.: US 2026/0170369 A1
(43) Pub. Date: Jun. 18, 2026

(54) MULTI-TASK COLLABORATIVE ATTENTION TSK FUZZY SYSTEM MODELING METHOD FOR FERMENTED FOOD SAFETY ASSESSMENT

(71) Applicant: JIANGNAN UNIVERSITY, JIANGSU (CN)

(72) Inventors: ZhaoHong DENG, Jiangsu (CN); ZhuangZhuang ZHAO, Jiangsu (CN); ChenXi LUO, Jiangsu (CN); ShiTong WANG, Jiangsu (CN)

(73) Assignee: JIANGNAN UNIVERSITY, JIANGSU (CN)

(21) Appl. No.: 19/026,599

(22) Filed: Jan. 17, 2025

(30) Foreign Application Priority Data
Dec. 13, 2024 (CN) 202411840086.9

(51) Int. Cl. G06N 7/02

(52) U.S. Cl. CPC G06N 7/023

(57) ABSTRACT

The present invention belongs to the field of intelligent computing, and specifically relates to a multi-task collaborative attention TSK fuzzy system modeling method, which is used to provide an interpretable multi-task intelligent evaluation model for fermentation food safety assessment. The method includes two main parts: a new multi-task TSK fuzzy system model structure and a multi-task collaborative optimization process. In the intelligent evaluation model, the proposed multi-task collaborative processing unit is used to perform collaboration among multiple evaluation tasks. By using the multi-task feature selection layer and task attention structure respectively to extract the unique information of each task and the relevant information between tasks, the evaluation performance of each evaluation task can be better improved. In the collaborative optimization process, the present invention uses multi-task collaborative regularization to achieve more efficient mining and utilization of the unique information of each task.

### CROSS-REFERENCE TO RELATED APPLICATION

This application claims the priority benefit of China application serial no. 202411840086.9, filed on Dec. 13, 2024. The entirety of the above-mentioned patent application is hereby incorporated by reference herein and made a part of this specification.

### BACKGROUND

### Technical Field

The present invention belongs to the field of intelligent computing, and particularly relates to a multi-task collaborative attention TSK fuzzy system modeling method for fermented food safety assessment.

### Description of Related Art

The safety assessment of fermented foods during production stages often involves a variety of evaluation tasks and indicators. Taking Huangjiu (a type of Chinese rice wine) as an example, its production safety assessment includes multiple stages, such as raw material treatment (rice soaking, steaming, cooling, and fermentation initiation), saccharification, fermentation (primary and secondary fermentation), pressing, distillation, blending, and bottling. Each task may involve safety assessments of various risks, such as biological contamination, chemical contamination (heavy metals, plasticizers), and quality evaluations of taste and flavor. For example, in the primary fermentation stage of Huangjiu, the safety assessment includes evaluating alcohol content, sugar content, and acidity. In the blending and bottling stages, the evaluation primarily involves assessing the quality and grade of the wine based on data from sugar content, acidity, alcohol, higher alcohols, as well as sensory data such as appearance and smell. Many fermented foods production processes often involve traditional techniques, and safety assessments based on testing data sometimes require human expertise. Currently, the intelligent modeling process for fermented food safety assessments lacks interpretability, making it difficult to explore the potential correlations between multiple safety assessment tasks, as well as to clearly establish the correspondence between associated factors and evaluation indicators.

Through in-depth research, it has been found that the intelligent evaluation of fermented food safety is still in its early stages, with limited technical accumulation. Furthermore, several key technical challenges need to be addressed: (1) The safety assessment of fermented foods often involves multiple evaluation tasks across various stages, including raw material processing, production, and distribution. Moreover, each evaluation task may involve multiple performance objectives. Therefore, there is an urgent need to develop intelligent model architectures suited for multi-task safety evaluation scenarios. (2) The interpretability of the safety assessment process is another core requirement for achieving intelligent evaluation. Thus, it is crucial to construct an interpretable reasoning mechanism for intelligent evaluation models and, based on this, develop a multi-task collaborative learning mechanism, which represents an important research direction.

Existing research on multi-task collaborative learning strategies for fermented food safety assessment can be broadly categorized into the following types. 1. Hard Collaborative Strategy: Different tasks share parameters of the lower-level network, while independent layers are used for the higher levels. This approach is suitable for highly related tasks; however, when tasks are unrelated or conflicting, negative transfer issues may arise. 2. Soft Collaborative Strategy: Each task has its own independent network, but parameters across tasks are encouraged to be similar through regularization or constraint mechanisms. This strategy can flexibly handle task heterogeneity and avoid negative transfer caused by excessive sharing. However, it requires careful design of the regularization term, necessitating a deep understanding of the relationships between tasks before modeling. 3. Hybrid Shared and Task-Specific Representation Strategy: The model learns both shared and task-specific representations for each task, combining these two to improve model performance. This approach balances the commonalities and differences between tasks, adapting flexibly to the needs of different tasks. However, it can lead to a more complex model structure and training process. 4. Task Relationship Modeling Strategy: This strategy explicitly models the relationships between tasks and incorporates the learned task dependencies into the sharing strategy. It offers greater flexibility and interpretability, allowing the level of sharing to be adjusted based on the task relationships. However, it requires prior knowledge or additional steps to learn task relationships. In summary, the design of multi-task sharing strategies still faces significant challenges in current research.

There are two main strategies for providing interpretable reasoning mechanisms for multi-task models. The first approach is to use inherently interpretable models, such as linear models, tree-based models, and rule-based models. The second approach involves post-hoc interpretability methods, which use techniques like visualization and instance-based explanations to interpret the model's decision-making process while maintaining model performance. The TSK fuzzy system is a rule-based interpretable model that also possesses strong data-driven learning capabilities, which has led to widespread attention and significant advancements in the multi-task learning field in recent years. As discussed in this review, building efficient and transparent multi-task learning algorithms remains a challenging task.

### SUMMARY

According to the defects in the prior art, the present invention provides a multi-task collaborative attention TSK fuzzy system modeling method (MTCA_TSK) for fermented food safety assessment. The invention mainly consists of two parts: First, a new multi-task fuzzy rule structure is designed as a shared strategy for coordinating multiple safety evaluation tasks, followed by the construction of a multi-task TSK fuzzy system model. Then, a model optimization algorithm based on collaborative learning regularization is designed for the multi-task TSK fuzzy system.

The present invention has the following technical solution:

A multi-task collaborative attention TSK fuzzy system modeling method for fermented food safety assessment, comprising the following steps:
Step 1: identifying the multi-task dataset

$${\{ {x}_{k} ∈ {i}^{{N}_{k} \times D} , {y}_{k} ∈ {i}^{{N}_{k}} \}}_{k = 1}^{K}$$

for fermented food safety assessments, consisting of K tasks, where each task has the same feature dimension D, and the number of samples for each task is Nₖ; and
Step 2: based on the number of tasks and the feature dimensions in the dataset, determine the number of rules R for the TSK fuzzy system. Define the basic structure of the multi-task fuzzy rules and construct and initialize the MTCA_TSK model:
Step 2.1, define the structure of the multi-task fuzzy rules. The rule antecedents use a set of fuzzy sets based on Gaussian membership functions, while the rule consequents use a multi-task collaborative processing unit

$${f}_{MT - CoPU}^{r} ( x ) .$$

The output of the fuzzy rule antecedent is computed as follows:

$${φ}^{r} ( x ) = exp ( - {{\sum }^{D}}_{d = 1} \frac{{( {x}_{d} - {c}_{d}^{r} )}^{2}}{2 {σ}_{d}^{r}} ) \qquad ( 1 )$$

The output of the fuzzy rule consequent is computed as follows:

$${y}^{r} = {f}_{MT - CoPU}^{r} ( x ) \qquad ( 2 )$$

Step 2.2, multi-task collaborative processing unit

$${f}_{MT - CoPU}^{r} ( x )$$

The multi-task collaborative processing unit

$${f}_{MT - CoPU}^{r} ( x )$$

consists of a multi-task feature selection layer, a task collaboration attention structure, and decision-makers corresponding to each task. In the multi-task collaborative processing unit

$${f}_{MT - CoPU}^{r} ( x )$$

Step 2.2.1, using the multi-task feature selection layer, the discriminative features H^{r}ϵj^{K×D} for each task are extracted from the input x using the following equation:

$$\begin{matrix}{H}^{r} = [ {h}_{1 :}^{r} : {h}_{2 :}^{r} ; L ; {h}_{K :}^{r} ] \\ = norm ( [ x e {w}_{r , : 1}^{T} ; x e {w}_{r ; 2}^{T} ; L ; x e {w}_{r , ; K}^{r} ] )\end{matrix} \qquad ( 3 )$$

where Wᵣϵj^{D×K} is the multi-task feature selection matrix, and the k-th column

$${w}_{r , ; k}^{T}$$

is used to extract the discriminative features

$$x e {w}_{r , ; k}^{T}$$

for the k-th task, where e denotes the Hadamard product. The norm refers to the BatchNorm layer, which is used to maintain the numerical scale of the discriminative features.

Step 2.2.2, using task attention structure, the aggregated features for each task are extracted using the following equation:

$${g}_{k :}^{r} = \frac{{\sum }_{t = 1}^{K} E ( {h}_{k :}^{r} , {h}_{t :}^{r} ) \cdot ( {h}_{t :}^{r} {V}^{r} )}{{\sum }_{s = 1}^{K} E ( {h}_{k :}^{r} , {h}_{s :}^{r} )} \qquad ( 4 )$$

$$E ( {h}_{s :} , {h}_{t :} ) = exp ( - \frac{{‖ {h}_{s :} {P}^{r} - {h}_{t :} {P}^{r} ‖}^{2}}{{hD}_{k}} ) \qquad ( 5 )$$

where V^{r}ϵj^{D×D}^{ᵥ} is the feature mapping matrix that maps the discriminative features from the D-dimensional space to the Dᵥ-dimensional target space. P^{r}ϵj^{=D×D}^{ᵥ} is also a feature mapping matrix, and Dₖ is the dimension of the mapped features.

Step 2.2.3, based on the obtained discriminative features and aggregated features, the output of the multi-task collaborative processing unit is computed as:

$${f}_{MT - CoPU}^{r} ( x ) = \{ \begin{matrix}{h}_{1 :}^{r} {b}_{: 1}^{r} + {g}_{1 :}^{r} {q}_{: 1}^{r} , & x ∈ {X}_{1} \\ {h}_{2 :}^{r} {b}_{: 2}^{r} + {g}_{k :}^{r} {q}_{: 2}^{r} , & x ∈ {X}_{2} \\ M & M \\ {h}_{K :}^{r} {b}_{: K}^{r} + {g}_{K :}^{r} {q}_{: K}^{r} , & x ∈ {X}_{K}\end{matrix} \qquad ( 6 )$$

Step 2.3, initialize model parameters:

Determine the number of fuzzy rules R. Use K-means clustering to determine the antecedent parameters

$${c}_{d}^{r}$$

of each multi-task fuzzy rule. Initialize the antecedent parameter

$${σ}_{d}^{r}$$

to 1. Initialize all parameters in the consequent using uniform distribution U(0,1).

Step 3: construct the objective function of the multi-task TSK fuzzy system and optimize the model.

Construct the objective function of the multi-task TSK fuzzy system. The formula is as follows:

$$J ( {W}^{*} ) = {\sum }_{k = 1}^{K} {‖ {y}_{k} - {\hat{y}}_{k} ‖}_{F}^{2} + {\sum }_{r = 1}^{R} ( α {‖ {W}_{r} ‖}_{2 , 1} + β {‖ {W}_{r} ‖}_{1 , 1} ) \qquad ( 7 )$$

where ŷₖ is the evaluation result of the dataset Xₖ of the k-th task on the multi-task fuzzy system.

1) The first term

$${\sum }_{k = 1}^{K} ‖ {y}_{k} - {\hat{y}}_{k} {‖}_{F}^{2}$$

is the evaluation error term and is used to train the parameters of the multi-task fuzzy system.

2) The second term

$${\sum }_{r = 1}^{R} ( α {‖ {W}_{r} ‖}_{2 , 1} )$$

is used to identify a single feature shared among multiple tasks in a single rule.

3) The third term

$${\sum }_{r = 1}^{R} ( β {‖ {W}_{r} ‖}_{1 , 1} )$$

is used to study whether a single feature in a single rule is effective for a specific task.

Taking formula (7) as the objective function, the AdamW optimizer is selected and the mini-batch gradient descent (MBGD) method is used to optimize the proposed multi-task fuzzy system model to obtain the optimal solution of the model parameters.

Step 4: obtain the final evaluation result of the multi-task TSK fuzzy system.

According to the following formula, the evaluation process of the multi-task fuzzy system for the input xϵXₖ is obtained.

$$\hat{y} = \frac{{\sum }_{r = 1}^{R} {φ}^{r} ( x ) {y}^{r}}{{\sum }_{s = 1}^{R} {φ}^{s} ( x )} \qquad ( 8 )$$

The advantages of the present invention include the following points:

1) Different from existing methods, the present invention proposes an intelligent evaluation model named MTCA_TSK for the safety assessment of fermented foods. This model designs a multi-task fuzzy rule that uses a multi-task collaborative processing unit as the consequent of the rule. The multi-task fuzzy rule can mine its own unique information for each evaluation task of fermented foods and extract relevant information from other related evaluation tasks, and be used for the evaluation and prediction of this task at the same time. Therefore, MTCA_TSK can be effectively applied to the multi-task modeling scenario of fermented food safety assessment.

2) The present invention selects the TSK fuzzy system as the basic model and uses interpretable multi-task fuzzy rules as the basic components. Therefore, the proposed MTCA_TSK model has strong interpretability. Therefore, the intelligent evaluation model constructed for fermented food safety assessment can have a good interpretable reasoning mechanism and can clearly give clear and definite reasoning basis for the reasoning process of each sample.

3) The effectiveness of this method is verified on real fermented data sets.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is the overall framework diagram of MTCA_TSK of the present invention.

FIG. 2 is the basic structure diagram of multi-task fuzzy rules.

### DESCRIPTION OF THE EMBODIMENTS

The present invention will be described in detail below in combination with the drawings and the embodiments.

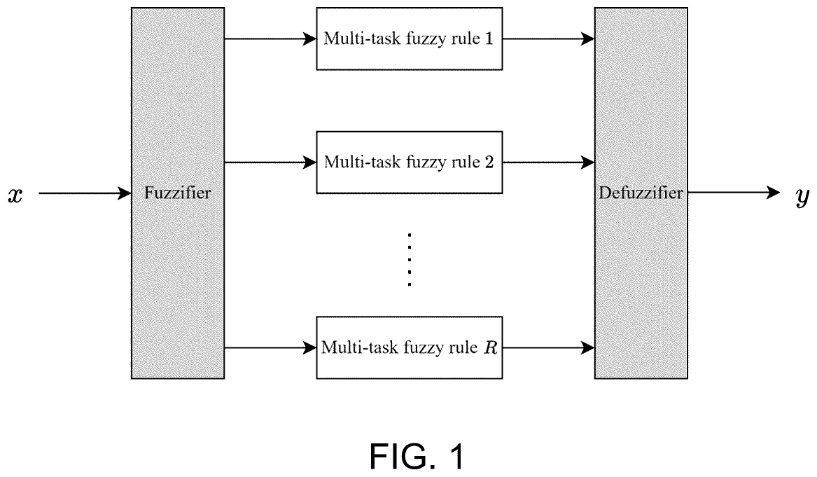

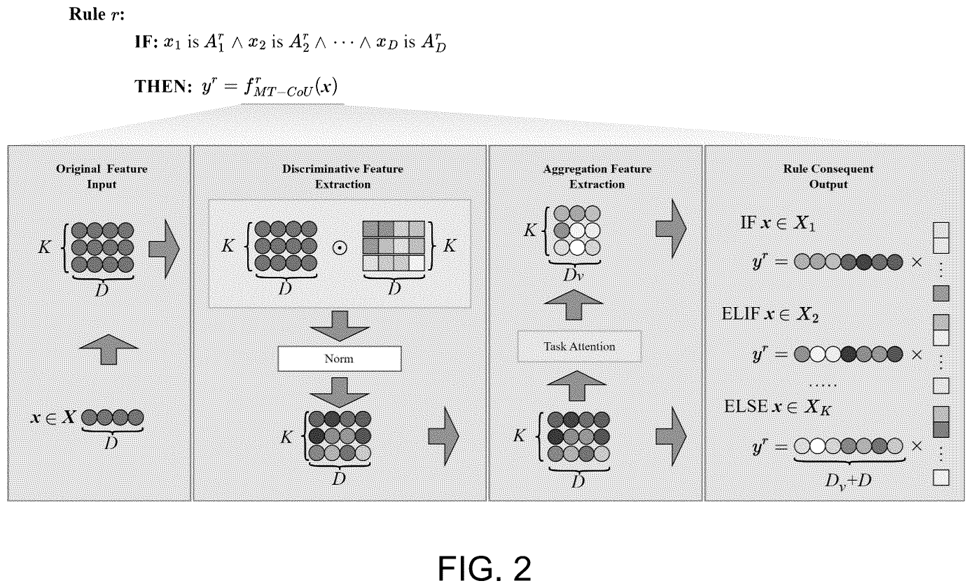

As shown in FIGS. 1-2, the present invention realizes a multi-task collaborative attention TSK fuzzy system modeling method for fermented food safety assessment.

This method includes two main parts: a new multi-task TSK fuzzy system intelligent evaluation model and a multi-task collaborative optimization method for model optimization. In the intelligent evaluation model, the proposed multi-task collaborative processing unit is used for collaboration among multiple evaluation tasks. By using the multi-task feature selection layer and task attention structure respectively to extract the unique information of each task and the relevant information between tasks, the evaluation performance of each evaluation task can be better improved. In the collaborative optimization process, the present invention uses multi-task collaborative regularization to achieve more efficient mining and utilization of the unique information of each task.

### Embodiment 1

A multi-task collaborative attention TSK fuzzy system modeling method for fermented food safety assessment includes the following steps:
step 1: identifying the number of tasks K, feature dimension D, and the number of samples Nₖ for each task of the dataset for training;
step 2: identifying the number of fuzzy rules of the model and other hyperparameters in the model;
step 3: perform k-means clustering on the dataset and initialize the model parameters of MTCA_TSK.
step 4: use the proposed optimization method to optimize the model parameters.
step 5: Obtain the final multi-task TSK fuzzy system model.

Glutamic Acid Fermentation Process Modeling Dataset (Fermentation): The glutamic acid fermentation process exhibits significant nonlinear and time-varying characteristics. The variables include fermentation time h, biomass concentration X(h), glutamic acid concentration P(h), glucose concentration S(h), agitation speed R(h), and aeration rate Q(h), where h=0,2,L,28 denotes the time point. The Fermentation dataset features three output variables: glucose concentration s(h+2), biomass concentration X(h), and glutamic acid concentration P(h+2) at time point h+2. Each output is treated as a separate prediction task, resulting in a multi-task dataset with three tasks.

Table 1 summarizes the evaluation results of the invented MTCA_TSK algorithm and six other comparison algorithms. The smaller the values of the evaluation indicators RMSE and RRSE, the better the performance of the model. In the experiment, the evaluation performance of each task in the Fermentation dataset and the comprehensive performance of the entire dataset are compared. For easy observation, we mark the optimal value in each comparison data with bold. From the experimental results in Table 1, it can be observed that: (1) On the Fermentation dataset, MTCA_TSK is superior to the comparison algorithms in the overall performance on Fermentation, indicating that the multi-task collaborative mechanism proposed in MTCA_TSK can well handle the correlation between evaluation tasks and then improve the overall performance of the model. (2) Observing the test results of three single-task models and four multi-task models, it can be seen that if the multi-task model can correctly analyze the relationship between different tasks and use a reasonable information sharing strategy, the multi-task model can significantly improve the overall performance on multiple tasks. (3) The goal of the multi-task model is to improve the overall optimal result on multiple tasks. Therefore, when the multi-task model achieves the best overall performance, it may not be optimal on a single task. That is, on a certain task, it may be inferior to the performance of some single-task models.

In more detail, a multi-task collaborative attention TSK fuzzy system modeling method for fermented food safety assessment, comprising the following steps:
Step 1: identifying the multi-task dataset

$${\{ {X}_{k} ∈ {i}^{{N}_{k} \times D} , {y}_{k} ∈ {i}^{{N}_{k}} \}}_{k = 1}^{K}$$

for fermented food safety assessments, consisting of K tasks, where each task has the same feature dimension D, and the number of samples for each task is Nₖ; and
Step 2: based on the number of tasks and the feature dimensions in the dataset, determine the number of rules R for the TSK fuzzy system. Define the basic structure of the multi-task fuzzy rules and construct and initialize the MTCA_TSK model:
Step 2.1, define the structure of the multi-task fuzzy rules. The rule antecedents use a set of fuzzy sets based on Gaussian membership functions, while the rule consequents use a multi-task collaborative processing unit

$${f}_{MT - CoPU}^{r} ( x ) .$$

The output of the fuzzy rule antecedent is computed as follows:

$${φ}^{r} ( x ) = exp ( - {\sum }_{d = 1}^{D} \frac{{( {x}_{d} - {c}_{d}^{r} )}^{2}}{2 {σ}_{d}^{r}} ) \qquad ( 1 )$$

The output of the fuzzy rule consequent is computed as follows:

$${y}^{r} = {f}_{MT - CoPU}^{r} ( x ) \qquad ( 2 )$$

Step 2.2, multi-task collaborative processing unit

$${f}_{MT - CoPU}^{r} ( x ) :$$

The multi-task collaborative processing unit

$${f}_{MT - CoPU}^{r} ( x )$$

consists of a multi-task feature selection layer, a task collaboration attention structure, and decision-makers corresponding to each task. In the multi-task collaborative processing unit

$${f}_{MT - CoPU}^{r} ( x ) :$$

Step 2.2.1, using the multi-task feature selection layer, the discriminative features H^{r}ϵi^{K×D} for each task are extracted from the input x using the following equation:

$$\begin{matrix}{H}^{r} = [ {h}_{1}^{r} ; {h}_{2}^{r} ; L ; {h}_{K :}^{r} ] \\ = norm ( [ x e {w}_{r , : 1}^{T} ; x e {w}_{r , : 2}^{T} ; x e {w}_{r , : K}^{T} ] )\end{matrix} \qquad ( 3 )$$

where Wᵣϵj^{D×K} is the multi-task feature selection matrix, and the k-th column

$${w}_{r , : k}^{T}$$

is used to extract the discriminative features

$$x e {w}_{r , : k}^{T}$$

for the k-th task, where e denotes the Hadamard product. The norm refers to the BatchNorm layer, which is used to maintain the numerical scale of the discriminative features.

Step 2.2.2, using task attention structure, the aggregated features for each task are extracted using the following equation:

$${g}_{k :}^{r} = \frac{{\sum }_{t = 1}^{K} E ( {h}_{k :}^{r} , {h}_{t :}^{r} ) \cdot ( {h}_{t :}^{r} {V}^{r} )}{{\sum }_{s = 1}^{K} E ( {h}_{k :}^{r} , {h}_{s :}^{r} )} \qquad ( 4 )$$

$$E ( {h}_{s :} , {h}_{t :} ) = exp ( - \frac{{‖ {h}_{s :} {P}^{r} - {h}_{t :} {P}^{r} ‖}^{2}}{{hD}_{k}} ) \qquad ( 5 )$$

where V^{r}ϵj^{D×D}^{ᵥ} is the feature mapping matrix that maps the discriminative features from the D-dimensional space to the Dᵥ-dimensional target space. P^{r}ϵj^{D×D}^{ₖ} is also a feature mapping matrix, and Dₖ is the dimension of the mapped features.

Step 2.2.3, based on the obtained discriminative features and aggregated features, the output of the multi-task collaborative processing unit is computed as:

$${f}_{MT - CoPU}^{r} ( x ) = \{ \begin{matrix}{h}_{1 :}^{r} {b}_{: 1}^{r} + {g}_{1 :}^{r} {q}_{: 1}^{r} , & x ∈ {X}_{1} \\ {h}_{2 :}^{r} {b}_{: 2}^{r} + {g}_{k :}^{r} {q}_{: 2}^{r} , & x ∈ {X}_{2} \\ M & M \\ {h}_{K :}^{r} {b}_{: K}^{r} + {g}_{K :}^{r} {q}_{: K}^{r} , & x ∈ {X}_{K}\end{matrix} \qquad ( 6 )$$

Step 2.3, initialize model parameters:

Determine the number of fuzzy rules R. Use K-means clustering to determine the antecedent parameters

$${c}_{d}^{r}$$

of each multi-task fuzzy rule. Initialize the antecedent parameter

$${σ}_{d}^{r}$$

to 1. Initialize all parameters in the consequent using uniform distribution U(0,1).

Step 3: construct the objective function of the multi-task TSK fuzzy system and optimize the model.

Construct the objective function of the multi-task TSK fuzzy system. The formula is as follows:

$$J ( {W}^{*} ) = {\sum }_{k = 1}^{K} {‖ {y}_{k} - {\hat{y}}_{k} ‖}_{F}^{2} + {\sum }_{r = 1}^{R} ( α {‖ {W}_{r} ‖}_{2 , 1} + β {‖ {W}_{r} ‖}_{1 , 1} ) \qquad ( 7 )$$

where ŷₖ is the evaluation result of the dataset Xₖ of the k-th task on the multi-task fuzzy system.

1) The first term

$${\sum }_{k = 1}^{K} {‖ {y}_{k} - {\hat{y}}_{k} ‖}_{F}^{2}$$

is the evaluation error term and is used to train the parameters of the multi-task fuzzy system.

2) The second term

$${\sum }_{r = 1}^{R} ( α {‖ {W}_{r} ‖}_{2 , 1} )$$

is used to identify a single feature shared among multiple tasks in a single rule.

3) The third term

$${\sum }_{r = 1}^{R} ( β {‖ {W}_{r} ‖}_{1 , 1} )$$

is used to study whether a single feature in a single rule is effective for a specific task.

Taking formula (7) as the objective function, the AdamW optimizer is selected and the mini-batch gradient descent (MBGD) method is used to optimize the proposed multi-task fuzzy system model to obtain the optimal solution of the model parameters.

Step 4: obtain the final evaluation result of the multi-task TSK fuzzy system.

According to the following formula, the evaluation process of the multi-task fuzzy system for the input xϵXₖ is obtained.

$$\hat{y} = \frac{{\sum }_{r = 1}^{R} {φ}^{r} ( x ) {y}^{r}}{{\sum }_{s = 1}^{R} {φ}^{s} ( x )} \qquad ( 8 )$$

### Embodiment 2

The present invention continues to analyze the effectiveness of the proposed task attention mechanism and collaborative regularization method. MTCA_TSK without task attention mechanism is called MTCA_TSK1, and MTCA_TSK without collaborative regularization is called MTCA_TSK2. The comparative experiments of the three algorithms are summarized in Table 2.

The results in Table 2 show that MTCA_TSK is superior to the MTCA_TSK1 and MTCA_TSK2 methods. At the same time, in most tasks, the performance of MTCA_TSK2 is better than that of MTCA_TSK1. These comparison results indicate that the proposed task attention mechanism can effectively promote the information exchange between tasks and thus improve the prediction performance of the model. In addition, the introduction of the collaborative regularization method can well assist the discriminative feature learning of each task and thus significantly improve the overall performance of the multi-task model.

TABLE 1
Performance Comparison of Different Algorithms on the
Fermentation Dataset (Mean + Variance)

| | Task | | | HTSK- | MT- | LRS- | | MTCA- |
|---|---|---|---|---|---|---|---|---|
| Indicators | id | SVR | HTSK | LN-ReLU | TSK-FS | MTTSK | MTDFS | TSK |
| RMSE | Task 1 | 1.0876 | 0.4831 | 0.5106 | 0.5010 | 0.4790 | 0.4770 | 0.4578 |
| | | 0.0000 | 0.0103 | 0.0157 | 0.0000 | 0.0010 | 0.0152 | 0.0079 |
| | Task 2 | 0.0684 | 0.0564 | 0.0597 | 0.0581 | 0.0547 | 0.0549 | 0.0557 |
| | | 0.0000 | 0.0003 | 0.0008 | 0.0000 | 0.0000 | 0.0013 | 0.0012 |
| | Task 3 | 0.8045 | 0.3011 | 0.3374 | 0.2849 | 0.2796 | 0.2806 | 0.2959 |
| | | 0.0000 | 0.0086 | 0.0142 | 0.0000 | 0.0005 | 0.0081 | 0.0174 |
| | All | 0.7820 | 0.3303 | 0.3551 | 0.3345 | 0.3218 | 0.3211 | 0.3164 |
| | | 0.0000 | 0.0055 | 0.0094 | 0.0000 | 0.0005 | 0.0074 | 0.0075 |
| RRSE | Task 1 | 0.2157 | 0.0958 | 0.1013 | 0.0994 | 0.0950 | 0.0946 | 0.0908 |
| | | 0.0000 | 0.0020 | 0.0031 | 0.0000 | 0.0002 | 0.0030 | 0.0016 |
| | Task 2 | 0.3494 | 0.2882 | 0.3049 | 0.2969 | 0.2793 | 0.2806 | 0.2843 |
| | | 0.0000 | 0.0017 | 0.0139 | 0.0000 | 0.0001 | 0.0065 | 0.0060 |
| | Task 3 | 0.2251 | 0.0843 | 0.0944 | 0.0797 | 0.0782 | 0.0785 | 0.0828 |
| | | 0.0000 | 0.0024 | 0.0040 | 0.0000 | 0.0001 | 0.0023 | 0.0049 |
| | All | 0.1652 | 0.0698 | 0.0750 | 0.0706 | 0.0680 | 0.0678 | 0.0668 |
| | | 0.0000 | 0.0012 | 0.0020 | 0.0000 | 0.0001 | 0.0016 | 0.0016 |

TABLE 2
Comparison Results of MTCA_TSK1, MTCA TSK2 and MTCA
TSK on the Fermentation Dataset (Mean + Variance)

| | Task | RMSE RRSE | | | RRSE | | |
|---|---|---|---|---|---|---|---|
| Dataset | id | MTCA_TSK2 | MTCA_TSK1 | MTCA_TSK | MTCA_TSK2 | MTCA_TSK1 | MTCA_TSK |
| Fermentation | Task 1 | 0.4798 | 0.4695 | 0.4578 | 0.0951 | 0.0931 | 0.0908 |
| | | 0.0268 | 0.0312 | 0.0079 | 0.0053 | 0.0062 | 0.0016 |
| | Task 2 | 0.0560 | 0.0564 | 0.0557 | 0.2862 | 0.2879 | 0.2843 |
| | | 0.0026 | 0.0025 | 0.0012 | 0.0135 | 0.0126 | 0.0060 |
| | Task 3 | 0.3139 | 0.3009 | 0.2959 | 0.0878 | 0.0842 | 0.0828 |
| | | 0.0384 | 0.0183 | 0.0174 | 0.0107 | 0.0051 | 0.0049 |
| | All | 0.3328 | 0.3240 | 0.3164 | 0.0703 | 0.0684 | 0.0668 |
| | | 0.0242 | 0.0138 | 0.0075 | 0.0051 | 0.0029 | 0.0016 |

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A multi-task collaborative attention TSK fuzzy system modeling method for fermented food safety assessment, comprising the following steps:
step 1: identifying the multi-task dataset
$${\{ {X}_{k} ∈ {i}^{{N}_{k} \times D} , {y}_{k} ∈ {i}^{{N}_{k}} \}}_{k = 1}^{K}$$
for fermented food safety assessments, consisting of K tasks, where each task has the same feature dimension D, and the number of samples for each task is Nₖ; and
step 2: based on the number of tasks and the feature dimensions in the dataset, determining the number of rules R for the TSK fuzzy system, defining the basic structure of the multi-task fuzzy rules and construct and initialize the MTCA_TSK model, comprising:
step 2.1, defining the structure of the multi-task fuzzy rules:
the rule antecedents use a set of fuzzy sets based on Gaussian membership functions, while the rule consequents use a multi-task collaborative processing unit
$${f}_{MT - CoPU}^{r} ( x ) ,$$
the output of the fuzzy rule antecedent is computed as follows:
$${φ}^{r} ( x ) = exp ( - {\sum }_{d = 1}^{D} \frac{{( {x}_{d} - {c}_{d}^{r} )}^{2}}{2 {σ}_{d}^{r}} ) \qquad ( 1 )$$
the output of the fuzzy rule consequent is computed as follows:
$${y}^{r} = {f}_{MT - CoPU}^{r} ( x ) \qquad ( 2 )$$
step 2.2, the structure of multi-task collaborative processing unit
$${f}_{MT - CoPU}^{r} ( x )$$
as follows:
the multi-task collaborative processing unit
$${f}_{MT - CoPU}^{r} ( x )$$
consists of a multi-task feature selection layer, a task collaboration attention structure, and decision-makers corresponding to each task; and
step 2.3, initializing model parameters:
determining the number of fuzzy rules R, using K-means clustering to determine the antecedent parameters
$${c}_{d}^{r}$$
of each multi-task fuzzy rule, initializing the antecedent parameter
$${σ}_{d}^{r}$$
to 1, initializing all parameters in the consequent using uniform distribution U(0,1);
step 3: constructing the objective function of the multi-task TSK fuzzy system and optimize the model; and
step 4: obtaining the final evaluation result of the multi-task TSK fuzzy system.

2. The multi-task collaborative attention TSK fuzzy system modeling method for fermented food safety assessment of claim 1, wherein the step 3 comprises:
constructing the objective function of the multi-task TSK fuzzy system, the formula is as follows:
$$J ( {W}^{*} ) = {\sum }_{k = 1}^{K} {‖ {y}_{k} - {\hat{y}}_{k} ‖}_{F}^{2} + {\sum }_{r = 1}^{R} ( α {‖ {W}_{r} ‖}_{2 , 1} + β {‖ {W}_{r} ‖}_{1 , 1} ) \qquad ( 7 )$$
where ŷₖ is the evaluation result of the dataset Xₖ of the k-th task on the multi-task fuzzy system;
taking formula (7) as the objective function, the AdamW optimizer is selected and the mini-batch gradient descent (MBGD) method is used to optimize the proposed multi-task fuzzy system model to obtain the optimal solution of the model parameters.

3. The multi-task collaborative attention TSK fuzzy system modeling method for fermented food safety assessment of claim 1, wherein the step 4 comprises:
according to the following formula, the evaluation process of the multi-task fuzzy system for the input xϵXₖ is obtained:
$$\hat{y} = \frac{{\sum }_{r = 1}^{R} {φ}^{r} ( x ) {y}^{r}}{{\sum }_{s = 1}^{R} {φ}^{s} ( x )} . \qquad ( 8 )$$

4. The multi-task collaborative attention TSK fuzzy system modeling method for fermented food safety assessment of claim 1, wherein the step 2.2 comprises:
in the multi-task collaborative processing unit
$${f}_{MT - CoPU}^{r} ( x ) :$$
step 2.2.1, using the multi-task feature selection layer, the discriminative features H^{r}ϵj^{K×D} for each task are extracted from the input x using the following equation:
$$\begin{matrix}{H}^{r} = [ {h}_{1 :}^{r} ; {h}_{2 :}^{r} ; L ; {h}_{K :}^{r} ] \\ = norm ( [ {xew}_{r , : 1}^{T} ; {xew}_{r , : 2}^{T} ; L ; {xew}_{r , : K}^{T} ] )\end{matrix} \qquad ( 3 )$$
where Wᵣϵj^{D×K} is the multi-task feature selection matrix, and the k-th column
$${w}_{r , : k}^{T}$$
is used to extract the discriminative features
$${xew}_{r , : k}^{T}$$
for the k-th task, where e denotes the Hadamard product, wherein the norm refers to the BatchNorm layer used to maintain the numerical scale of the discriminative features;
step 2.2.2, using task attention structure, the aggregated features for each task are extracted using the following equation:
$${g}_{k :}^{r} = \frac{{\sum }_{t = 1}^{K} E ( {h}_{k :}^{r} , {h}_{t :}^{r} ) \cdot ( {h}_{t :}^{r} {V}^{r} )}{{\sum }_{s = 1}^{K} E ( {h}_{k :}^{r} , {h}_{s :}^{r} )} \qquad ( 4 )$$
$$E ( {h}_{s :} , {h}_{t :} ) = exp ( - \frac{{‖ {h}_{s :} {P}^{r} - {h}_{t :} {P}^{r} ‖}^{2}}{{hD}_{k}} ) \qquad ( 5 )$$
where V^{r}ϵj^{DλD}^{ᵥ} is the feature mapping matrix that maps the discriminative features from the D-dimensional space to the Dᵥ-dimensional target space, P^{r}ϵj^{D×D}^{ₖ} is also a feature mapping matrix, and Dₖ is the dimension of the mapped features;
step 2.2.3, based on the obtained discriminative features and aggregated features, the output of the multi-task collaborative processing unit is computed as:
$${f}_{MT - CoPU}^{r} ( x ) = \{ \begin{matrix}{h}_{1 :}^{r} {b}_{: 1}^{r} + {g}_{1 :}^{r} {q}_{: 1}^{r} , & x ∈ {X}_{1} \\ {h}_{2 :}^{r} {b}_{: 2}^{r} + {g}_{k :}^{r} {q}_{: 2}^{r} , & x ∈ {X}_{2} \\ M & M \\ {h}_{K :}^{r} {b}_{: K}^{r} + {g}_{K :}^{r} {q}_{: K}^{r} , & x ∈ {X}_{K}\end{matrix} . \qquad ( 6 )$$
